(19) United States
(12) Patent Application Publication
(10) Pub. No.: US 2024/0423111 A1
(43) Pub. Date: Dec. 26, 2024

(54) COUPLING ASSEMBLY FOR A THREE-POINT HITCH OF AN AGRICULTURAL TRACTOR

(71) Applicant: DEERE & COMPANY, MOLINE, IL (US)

(72) Inventor: ACHIM SCHIBEL, HEIDELBERG (DE)

(21) Appl. No.: 18/669,661

(22) Filed: May 21, 2024

(30) Foreign Application Priority Data
Jun. 21, 2023 (DE) 102023116206.3

(51) Int. Cl. A01B 59/00; A01B 59/06

(52) U.S. Cl. CPC A01B 59/006; A01B 59/067

(57) ABSTRACT

A coupling assembly for a three-point hitch of an agricultural tractor includes a lower link articulated on the tractor, a lift strut attached to the lower link, a catch hook at a free end of the lower link, the catch hook including a coupling body and a locking mechanism having a longitudinally movably mounted locking latch, a pull lever attached to the locking latch to deflect the locking latch, counter to a restoring spring force, out of a first locking position, which locks the catch hook, into a second locking position, which releases the catch hook, a deflection lever pivotably attached to the lift strut, and a first pull cable section connected to a free end of the pull lever and secured such that a pivoting movement at the deflection lever caused via a second pull cable section deflects the locking latch into the second locking position.

### CROSS-REFERENCE TO RELATED APPLICATIONS

This application claims priority to German Patent Application No. 102023116206.3, filed Jun. 21, 2023, which is hereby incorporated by reference.

### FIELD OF THE DISCLOSURE

The disclosure relates to a coupling assembly for a three-point hitch of an agricultural tractor.

### BACKGROUND

Agricultural tractors can include a three-point hitch for attaching implements to the tractor. The three-point hitch includes a pair of lower links and an upper link. The three-point hitch can include a hydraulically actuated lifting apparatus with a pair of lifting arms connected to the pair of lower links. Both the pair of lower links and the upper link have coupling hooks for receiving complementary fastening elements of an implement.

### SUMMARY

The disclosure relates to a coupling assembly for a three-point hitch of an agricultural tractor, comprising a lower link, articulated on the tractor, and a lift strut, attached thereto, for raising and lowering the lower link by means of a lift mechanism, wherein a catch hook that has a coupling body and a locking mechanism having a longitudinally movably mounted locking latch is provided at a free end of the lower link, wherein the locking latch can be deflected by means of a pull lever attached thereto, counter to a restoring spring force, out of a first locking position, which locks the catch hook, into a second locking position, which releases the catch hook.

Such a coupling assembly is known from DE 10 2021 113 462 A1. This comprises a coupling body having a catch hook for receiving a coupling element of complementary design to a fastening region of the catch hook along a defined receiving direction. A locking latch is mounted in a longitudinally movable manner in a sliding guide, provided on the coupling body, in such a way that it can be deflected out of a locking rest position perpendicularly to the defined receiving direction, thereby clearing the fastening region, whereas the locking latch, when in the locking rest position, projects more than half way beyond the fastening region in the defined receiving direction, thereby performing a locking function. If a coupling element designed as a coupling ball is situated in the fastening region, the locking latch accordingly extends beyond the apex, which faces the locking latch in the receiving direction. The locking mechanism thus created very largely excludes the possibility of unintentional opening of the locking latch due to the effects of forces on the coupling element that occur in the course of operation. A pull lever is attached to the locking latch, by means of which the locking latch can be deflected manually out of the locking rest position by the operator. For this purpose, the pull lever or a hand piece formed thereon extends outward through a rear outlet opening provided on a housing of the coupling body. To open the locking mechanism when decoupling an agricultural attachment or ancillary implement attached to the three-point hitch, the driver therefore has to leave the driver's cab or ask someone else for help.

It is the object of the present disclosure to improve a coupling assembly of the type stated at the outset in respect of its user-friendliness.

This object is achieved by a coupling assembly for a three-point hitch of an agricultural tractor having the features of one or more of the following embodiments.

The coupling assembly for a three-point hitch of an agricultural tractor comprises a lower link, articulated on the tractor, and a lift strut, attached thereto, for raising and lowering the lower link by means of a lift mechanism, wherein a catch hook that has a coupling body and a locking mechanism having a longitudinally movably mounted locking latch is provided at a free end of the lower link, wherein the locking latch can be deflected by means of a pull lever attached thereto, counter to a restoring spring force, out of a first locking position, which locks the catch hook, into a second locking position, which releases the catch hook. According to the disclosure, a deflection lever is pivotably attached to the lift strut, on the free end of which lever a first pull cable section connected to the pull lever is secured in such a way that a pivoting movement brought about at the deflection lever by means of a second pull cable section leads to a deflection of the locking latch into the second locking position.

The use of a deflection lever means that the path of the second pull cable section does not necessarily have to correspond to the direction of deflection of the locking latch but can have an orientation that differs therefrom. Appropriate arrangement of the deflection lever on the lift strut thus makes it possible, for the sake of convenient operation by hand, for the end of the second pull cable section to be routed, in particular, along the lift strut (which extends upward between the lower link and a lift arm of the lift mechanism) and thus in the direction of a rear window opening of a driver's cab of the agricultural tractor. This makes it possible, when decoupling an agricultural attachment or ancillary implement attached to the three-point hitch, for the driver to open the locking mechanism “from a distance” and thus at a safe distance by pulling on the second pull cable section, without leaving the driver's cab or receiving assistance from someone else.

In this case, the second pull cable section can be attached by means of a snap hook to an end region of the pull lever which extends outward at the rear from a housing of the coupling body.

Advantageous embodiments of the coupling assembly according to the disclosure will become apparent from one or more of the embodiments described herein.

The second pull cable section is for example secured to the free end of the deflection lever independently of the first pull cable section. Accordingly, it is conceivable that there are two separate pull cable sections, each of which is mounted on the deflection lever by means of a dedicated fastening element. In the event of a replacement that is to be carried out owing to damage, only the affected section has to be replaced.

For the sake of simplified assembly with just one fastening element on the deflection lever, it is also possible, however, to provide for the first and second pull cable sections to be parts of a continuous pull cable.

Irrespective of whether the pull cable is of continuous design or is divided into mutually independent pull cable sections, this cable typically has a flexible core composed of steel strands or high-strength plastic fibers, which is surrounded by a protective plastic sheath.

Since the three-point hitch has left-hand and right-hand lower links, and therefore there are left-hand and right-hand coupling assemblies, it is conceivable that their respectively associated second pull cable sections are connected to one another at their open ends or are designed as a continuous pull cable. The cable loop thus formed simplifies one-handed operation.

There is furthermore the possibility that a movement of the first pull cable section directed transversely to the deflection of the locking latch on account of the pivoting movement of the deflection lever serves for the actuation of a latching mechanism, which retains the locking latch in the second locking position. The latching mechanism makes use of the fact that the first pull cable section describes an arc that follows the pivoting movement of the deflection lever. In this arrangement, the pull lever is attached in an articulated manner to the locking latch in such a way that a step-shaped recess or latching nose formed on the pull lever, following the arc-shaped movement of the first pull cable section, can be reversibly hooked into an edge of a rear outlet opening of the coupling body or of the housing surrounded by the latter as soon as the second locking position has been reached. Decoupling of an agricultural attachment or ancillary implement from the three-point hitch is thereby further simplified.

The above and other features will become apparent from the following detailed description and accompanying drawings.

### BRIEF DESCRIPTION OF THE DRAWINGS

The coupling assembly according to the disclosure is explained in more detail hereinafter with reference to the appended drawings. Here, corresponding reference signs relate to identical components or components which are comparable with respect to their function. In the drawings:

FIG. 1 shows an exemplary embodiment of the coupling assembly according to the disclosure on a three-point hitch, a section of which is illustrated, having a locking latch which is in a first locking position, in which it locks a catch hook;

FIG. 2 shows an illustration of the coupling assembly according to the disclosure as per FIG. 1, in which the locking latch is in a second locking position, in which it releases the catch hook;

FIG. 3 shows a detail view of a deflection lever included in the coupling assembly according to the disclosure as per FIG. 1; and

FIG. 4 shows a plan view of the coupling assembly according to the disclosure as per FIG. 1 in a direction of view along a lift strut attached to a lower link.

### DETAILED DESCRIPTION

The embodiments or implementations disclosed in the above drawings and the following detailed description are not intended to be exhaustive or to limit the present disclosure to these embodiments or implementations.

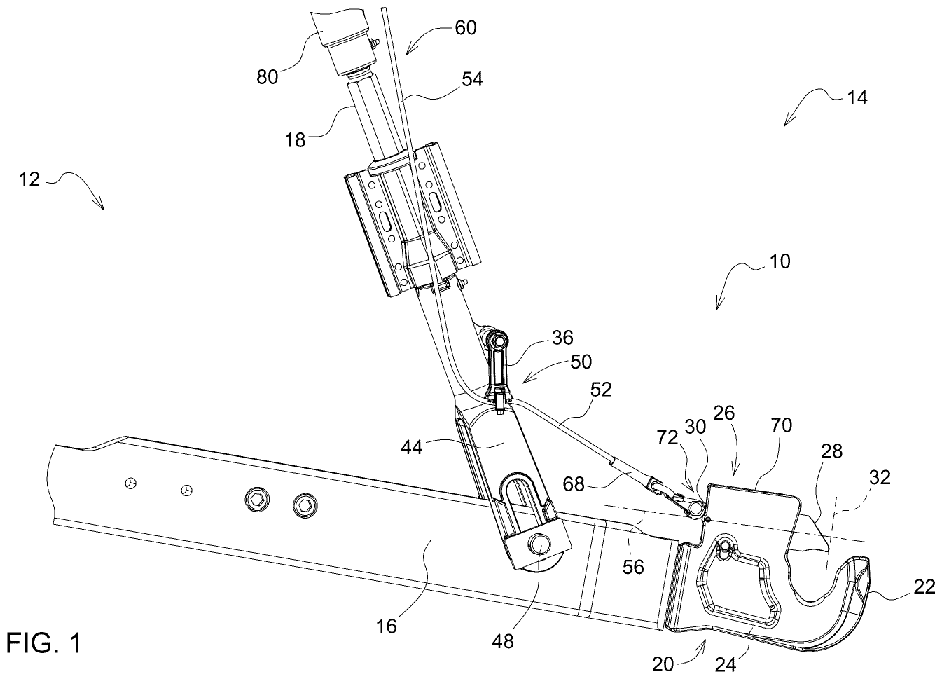

FIG. 1 shows an exemplary embodiment of the coupling assembly 10 according to the disclosure on a three-point hitch 12, a section of which is illustrated, of an agricultural tractor 14.

The three-point hitch 12 provided for the attachment of an agricultural attachment or ancillary implement is of conventional construction and comprises left-hand and right-hand lower links 16, which are mirror-symmetrical with respect to one another and of which only one of the two is reproduced for reasons of clarity. Each of the lower links 16 is pivotally attached in a lower region of a rear differential case (not shown) of the agricultural tractor 14 and can be raised and lowered at the instigation of an operator by means of a lift strut 18, which is hooked into a lift arm (not shown) of a hydraulic lift mechanism.

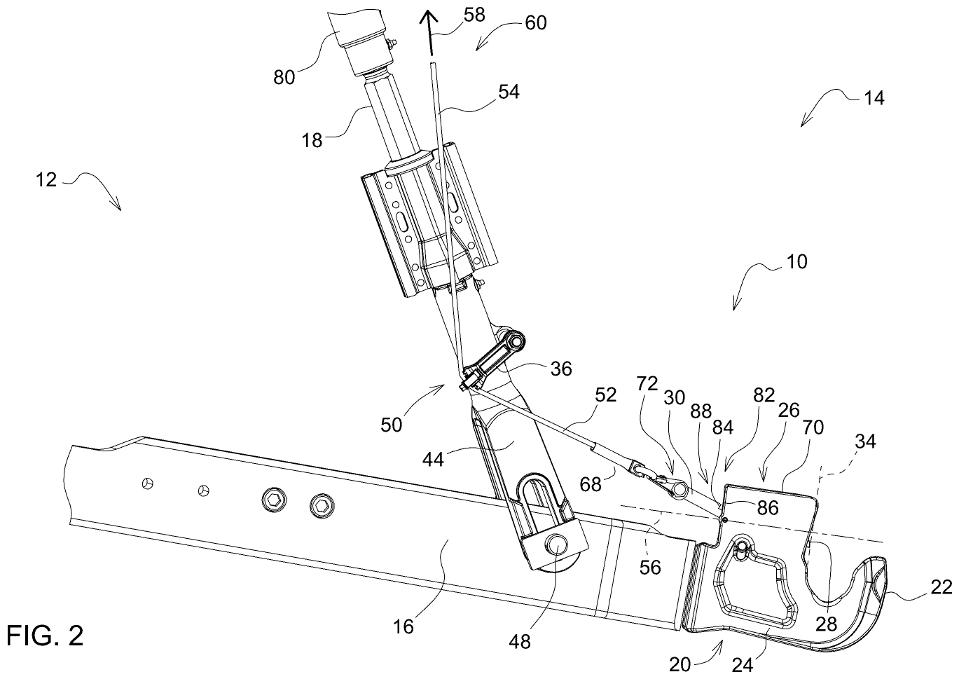

As can be seen in FIG. 1, in addition to the lower link 16 and the lift strut 18 attached thereto, the coupling assembly 10 has, at a free end 20 of the lower link 16, a catch hook 22 having a coupling body 24 and a locking mechanism 26 having a locking latch 28 movably mounted in the coupling body 24. The locking latch 28 can be deflected by means of a pull lever 30 attached thereto, counter to a restoring spring force, from a first locking position 32 shown in FIG. 1, in which it locks the catch hook 22, into a second locking position 34 shown in FIG. 2, in which it releases the catch hook 22.

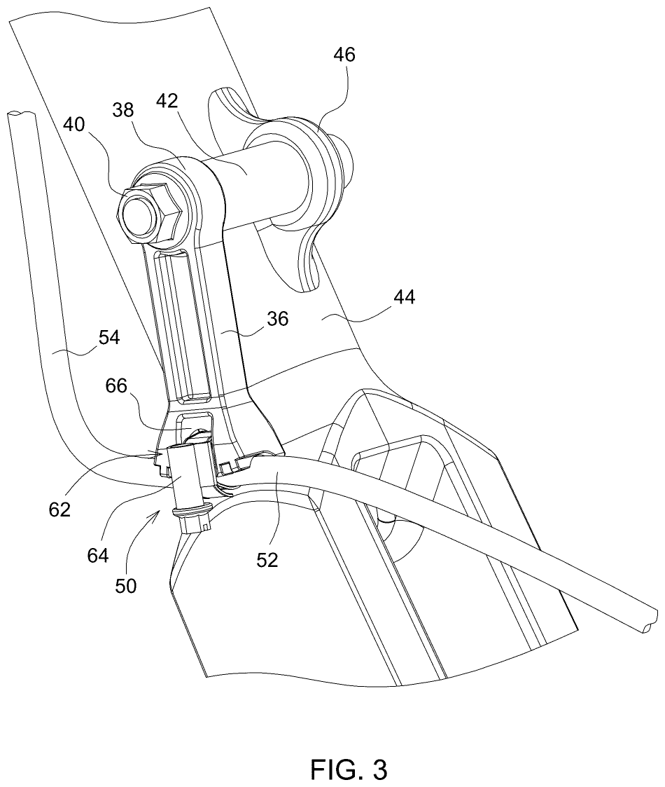

Furthermore, a deflection lever 36 depicted in detail in FIG. 3 is pivotably attached to each of the lift struts 18. In one example, the deflection lever 36 is a bone-shaped diecasting with a fastening eye 38 formed thereon, through which a bearing pin 42 screwed on by means of a collar nut 40 is passed, allowing rotary motion. The bearing pin 42 is firmly attached to a fastening projection 46 formed on a lower fastening fork 44 of the lift strut 18. The fastening projection 46 is an integral part of the lower fastening fork 44, which is attached to the lower link 16 by means of a releasable T-bolt 48.

At a free end 50 of the deflection lever 36, opposite the fastening eye 38, a first pull cable section 52 connected to the pull lever 30 is secured in such a way that a pivoting movement brought about at the deflection lever 36 by means of a second pull cable section 54 leads to a deflection of the locking latch 28 into the second locking position 34. For this purpose, the deflection lever 36 is situated at a point of the lift strut 18 which ensures that the first pull cable section 52 does not exceed an angle α of 40 to 70 degrees relative to the direction of deflection 56 of the locking latch 28 over the entire pivoting movement of the deflection lever 36. This ensures tilt-free and hence smooth actuation, on the part of the first pull cable section 52, of the locking latch 28 mounted within an associated sliding guide on the coupling body 24. The locking mechanism 26 is opened by pulling manually on the second pull cable section 54 (in the present case in arrow direction 58). In this case, the deflection lever 36 adopts the backward-pivoted position illustrated in FIG. 2.

According to the example, the first and second pull cable sections 52, 54 are part of a continuous pull cable 60. The pull cable 60 has a flexible core composed of steel strands or high-strength plastic fibers, which is surrounded by a protective plastic sheath.

In accordance with the illustration in FIG. 3, a fastening element 62 in the form of a conventional hose clamp 64 is used to secure the pull cable 60 on the deflection lever 36. The hose clamp 64 is passed through an opening 66 formed at the free end 50 of the deflection lever 36 and allows infinitely variable adjustment of the length of the first pull cable section 52.

As a departure therefrom, the second pull cable section 54 can also be secured to the free end 50 of the deflection lever 36 independently of the first pull cable section 52. In this case, there are two separate pull cable sections, each of which is mounted on the deflection lever 36 by means of a dedicated fastening element. In the event of a replacement that is to be carried out owing to damage, only the affected section has to be replaced.

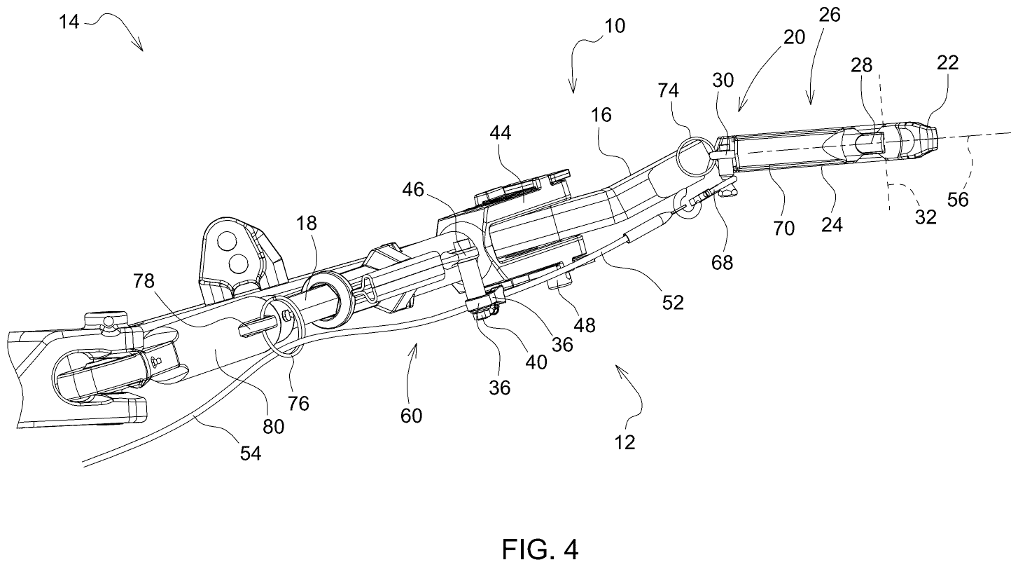

As can be seen especially in the plan view of FIG. 4, the first pull cable section 52 is attached by means of a snap hook 68 to an end region 72 of the pull lever 30 which extends outward at the rear from a housing 70 of the coupling body 24. If accidental opening of the locking mechanism 26 by pulling on the pull cable 60 is to be excluded in certain applications, the snap hook 68 can be removed from the pull lever 30 and stowed by being hooked onto the second pull cable section 54, for example. In this case, the pull lever 26 can be brought manually into the second locking position 34 indirectly by grasping an actuating ring 74 extending in the end region 72 thereof.

The selected positioning of the deflection lever 36 on the lift strut 18 makes it possible, for the sake of convenient operation by hand, for the end of the second pull cable section 54 to be routed along the lift strut 18, which extends upward between the lower link 16 and the lift arm, and thus in the direction of a rear window opening of a driver's cab of the agricultural tractor 14. For this purpose, the second pull cable section 54 is additionally passed through a retaining ring 76, which is received in a fixing eyelet 78 on an upper fastening fork 80 of the lift strut 18, said fork being hooked into the lift arm.

This makes it possible, when decoupling an agricultural attachment or ancillary implement attached to the three-point hitch 12, for the driver to open the locking mechanism 26 “from a distance” and thus at a safe distance by pulling on the second pull cable section 54, without leaving the driver's cab or receiving assistance from someone else.

Since the three-point hitch 12 has left-hand and right-hand lower links 16, and therefore there are left-hand and right-hand coupling assemblies 10, the respectively associated second pull cable sections 54 are connected to one another at their open ends or are designed as a continuous pull cable 60. The cable loop thus formed simplifies one-handed operation.

As can furthermore be seen in FIG. 2, the pull lever 30 is part of a latching mechanism 82, which makes it possible to retain the locking latch 28 temporarily in its second locking position 34, in which it releases the catch hook 22. The latching mechanism 82 makes use of the fact that the first pull cable section 52 describes an arc that follows the pivoting movement of the deflection lever 36, resulting in a movement of the first pull cable section 52 directed transversely to the deflection of the locking latch 28.

This can be used for the actuation of the latching mechanism 82. For this purpose, the pull lever 30 is attached in an articulated manner to the locking latch 28 in such a way that a step-shaped recess or latching nose 84 formed on the pull lever 30, following the arc-shaped movement of the first pull cable section 52, can be hooked into an edge 86 of a rear outlet opening 88 of the coupling body 24 or of the housing 70 surrounded by the latter as soon as the second locking position 34 has been reached.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A coupling assembly for a three-point hitch of an agricultural tractor, comprising:
a lower link articulated on the tractor;
a lift strut attached to the lower link for raising and lowering the lower link;
a catch hook at a free end of the lower link, the catch hook including a coupling body and a locking mechanism having a longitudinally movably mounted locking latch;
a pull lever attached to the locking latch to deflect the locking latch, counter to a restoring spring force, out of a first locking position, which locks the catch hook, into a second locking position, which releases the catch hook;
a deflection lever pivotably attached to the lift strut; and
a first pull cable section connected to a free end of the pull lever and secured such that a pivoting movement at the deflection lever caused via a second pull cable section deflects the locking latch into the second locking position.

2. The coupling assembly of claim 1, wherein the second pull cable section is secured to the free end of the deflection lever independently of the first pull cable section.

3. The coupling assembly of claim 1, wherein the first and second pull cable sections are portions of a continuous pull cable.

4. The coupling assembly of claim 1, wherein a movement of the first pull cable section directed transversely to the deflection of the locking latch owing to the pivoting movement of the deflection lever serves for the actuation of a latching mechanism, which retains the locking latch in the second locking position.

5. A three-point hitch of an agricultural tractor, comprising:
a lower link articulated on the tractor;
a lift strut attached to the lower link for raising and lowering the lower link;
a catch hook at a free end of the lower link, the catch hook including a coupling body and a locking mechanism having a longitudinally movably mounted locking latch;
a pull lever attached to the locking latch to deflect the locking latch, counter to a restoring spring force, out of a first locking position, which locks the catch hook, into a second locking position, which releases the catch hook;
a deflection lever pivotably attached to the lift strut; and
a first pull cable section connected to a free end of the pull lever and secured such that a pivoting movement at the deflection lever caused via a second pull cable section deflects the locking latch into the second locking position.

6. The three-point hitch of claim 5, wherein the second pull cable section is secured to the free end of the deflection lever independently of the first pull cable section.

7. The three-point hitch of claim 5, wherein the first and second pull cable sections are portions of a continuous pull cable.

8. The three-point hitch of claim 5, wherein a movement of the first pull cable section directed transversely to the deflection of the locking latch owing to the pivoting movement of the deflection lever serves for the actuation of a latching mechanism, which retains the locking latch in the second locking position.
